(19) United States
(12) Patent Application Publication
(10) Pub. No.: US 2026/0241796 A1
(43) Pub. Date: Aug. 20, 2026

(54) INFORMATION PROCESSING APPARATUS, INFORMATION PROCESSING METHOD, AND COMPUTER PROGRAM PRODUCT

(71) Applicant: Panasonic Automotive Systems Co., Ltd., Kanagawa (JP)

(72) Inventors: Takayuki SUZUKI, Kanagawa Ken (JP); Kazuki ITO, Kanagawa Ken (JP); Tetsuo NAKAMURA, Shiga Ken (JP); Masatoshi AKASAKA, Kanagawa Ken (JP); Akitoshi YAMASHITA, Hyogo Ken (JP); Yutaka KANAZAWA, Hyogo Ken (JP); Tatsuki HOTANI, Kanagawa Ken (JP)

(73) Assignee: Panasonic Automotive Systems Co., Ltd., Kanagawa (JP)

(21) Appl. No.: 19/542,071

(22) Filed: Feb. 17, 2026

(30) Foreign Application Priority Data
Feb. 18, 2025 (JP) 2025-024010

(51) Int. Cl. B60K 35/29; B60K 35/81; B60R 1/26; B60R 1/28; G06V 20/58

(52) U.S. Cl. CPC B60K 35/29; B60K 35/81; B60R 1/26; B60R 1/28; G06V 20/58; B60K 2360/176; B60K 2360/178; B60K 2360/1868

(57) ABSTRACT

An information processing apparatus includes a memory in which a program is stored, and a processor coupled to the memory and configured to perform processing by executing the program. The processing including displaying a rear image captured by a rear camera configured to image rear of an own vehicle on a display device provided on the own vehicle, wherein the processing including, when satisfying a first condition that there exists a two-wheeled vehicle not appearing in the rear image but appearing in rear side images captured by rear side cameras configured to image a left rear side and a right rear side of the own vehicle, display a second display image in which the rear side image is superimposed on a part of the rear image on the display device.

### CROSS-REFERENCE TO RELATED APPLICATIONS

This application is based upon and claims the benefit of priority from Japanese Patent Application No. 2025-024010, filed on February 18, 2025, the entire contents of which are incorporated herein by reference.

### FIELD

The present disclosure relates to an information processing apparatus, an information processing method, and a computer program product.

### BACKGROUND

In the related technology, a function of notifying a driver of another vehicle around an own vehicle has been introduced. For example, there is disclosed a function of displaying an image captured by a rear camera on an electronic mirror in a case where an inter-vehicle distance from a following vehicle is a predetermined distance or more, and displaying an image captured by a side camera on the electronic mirror in a case where the inter-vehicle distance is less than the predetermined distance.

A related technology is described in JP 2018-69862 A.

However, in the related technology, there is a case where the display on an electronic mirror is switched to the image of the side camera only even in a situation where it is necessary to cause the driver to confirm the image captured by the rear camera. Further, in the related art, even in a situation where it is necessary to cause the driver to confirm the image captured by the side camera, only the image of the rear camera is displayed on the electronic mirror in some cases. That is, in the related art, there is a case where visibility of a situation around the own vehicle is reduced.

An object of the present disclosure is to provide an information processing apparatus, an information processing method, and a computer program product capable of improving visibility of a situation around an own vehicle.

### SUMMARY

An information processing apparatus according to the present disclosure includes a memory in which a program is stored, and a processor coupled to the memory and configured to perform processing by executing the program. The processing including displaying a rear image captured by a rear camera configured to image rear of an own vehicle on a display device provided on the own vehicle, wherein the processing including, when satisfying a first condition that there exists a two-wheeled vehicle not appearing in the rear image but appearing in rear side images captured by rear side cameras configured to image a left rear side and a right rear side of the own vehicle, display a second display image in which the rear side image is superimposed on a part of the rear image on the display device.

### BRIEF DESCRIPTION OF THE DRAWINGS

FIG. 1 is a block diagram of an example of a functional configuration of an information processing apparatus;

FIG. 2 is a schematic diagram of an example of a travel environment of an own vehicle;

FIG. 3 is a schematic diagram illustrating a state in which a vehicle interior of the own vehicle is visually recognized on the vehicle front side;

FIG. 4 is a hardware configuration diagram of an example of the information processing apparatus;

FIG. 5A is a schematic diagram of an example of an image displayed on an electronic mirror;

FIG. 5B is a schematic diagram of an example of an image displayed on an electronic mirror;

FIG. 5C is a schematic diagram of an example of a second display image displayed on an electronic mirror;

FIG. 5D is a schematic diagram of an example of a second display image displayed on an electronic mirror;

FIG. 6A is a flowchart illustrating an example of a procedure of information processing executed by the information processing apparatus; and

FIG. 6B is a flowchart illustrating an example of a procedure of information processing executed by the information processing apparatus.

### DETAILED DESCRIPTION

Hereinafter, embodiments of an information processing apparatus, an information processing method, and an information processing program according to the present disclosure will be described with reference to the accompanying drawings.

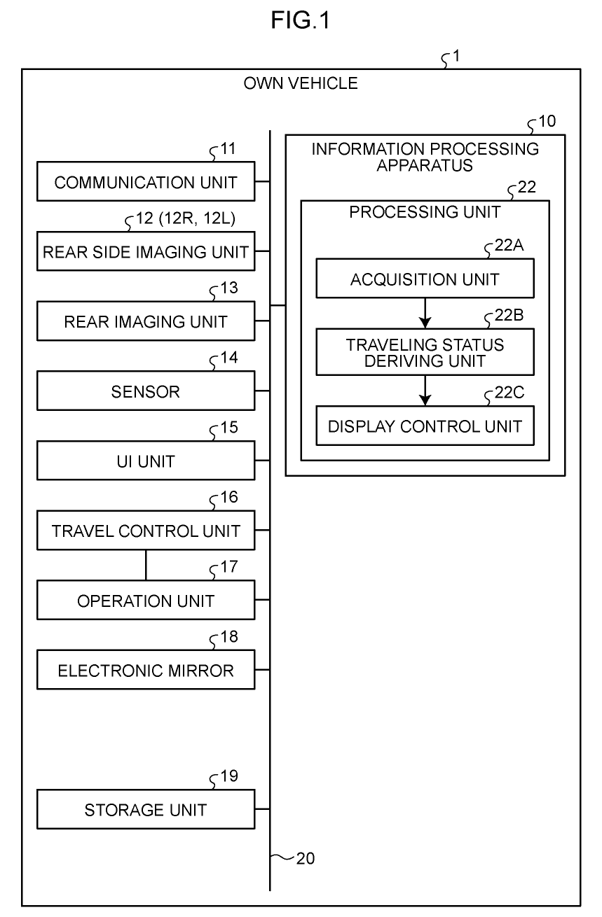

FIG. 1 is a block diagram of an example of a functional configuration of an information processing apparatus 10 according to the present embodiment.

The information processing apparatus 10 is an apparatus for improving visibility of a situation around another vehicle or the like around an own vehicle 1. In the present embodiment, a mode in which the information processing apparatus 10 is mounted on the own vehicle 1 will be described as an example.

The own vehicle 1 is a vehicle on which the information processing apparatus 10 is mounted. The other vehicle is a vehicle other than the vehicle on which the information processing apparatus 10 is mounted.

In the present embodiment, a mode in which the own vehicle 1 is a four-wheeled vehicle will be described as an example. In addition, the other vehicle includes a two-wheeled vehicle.

A two-wheeled vehicle is a vehicle having two wheels. The two-wheeled vehicle is, for example, a motorcycle, a scooter, a motorized bicycle, a bicycle, an electric kickboard, or the like. A four-wheeled vehicle is a vehicle having four or more wheels. The four-wheeled vehicle is, for example, a standard vehicle, a small-size vehicle, a med-size vehicle, a large-size vehicle, a light motor vehicle, a special vehicle, or the like.

The own vehicle 1 includes an information processing apparatus 10, a communication unit 11, a rear side imaging unit 12, a rear imaging unit 13, a sensor 14, a user interface (UI) unit 15, a travel control unit 16, an operation unit 17, an electronic mirror 18, and a storage unit 19.

The communication unit 11, the rear side imaging unit 12, the rear imaging unit 13, the sensor 14, the UI unit 15, the travel control unit 16, the operation unit 17, the electronic mirror 18, the storage unit 19, and the information processing apparatus 10 are communicably connected via a bus 20 or the like. For at least a part of the bus 20, for example, a local area network such as a controller area network (CAN) may be used.

The communication unit 11 is a communication interface that communicates with an external device. The communication unit 11 communicates with an external information processing apparatus via a network or the like, for example. Furthermore, the communication unit 11 may communicate with another vehicle by vehicle-to-vehicle communication or the like. For example, vehicle to vehicle (V2V) or the like is used for the vehicle-to-vehicle communication.

The rear side imaging unit 12 is an imaging device that images the rear side of the own vehicle 1 and obtains captured image data. The rear side imaging unit 12 is, for example, a camera. The rear imaging unit 13 is an imaging device that images the rear of the own vehicle 1 and obtains captured image data. The rear imaging unit 13 is, for example, a camera. Hereinafter, the captured image data will be simply referred to as a captured image. In the present embodiment, the rear side imaging unit 12 and the rear imaging unit 13 continuously perform imaging over time, and sequentially output the captured image obtained by the imaging to the information processing apparatus 10.

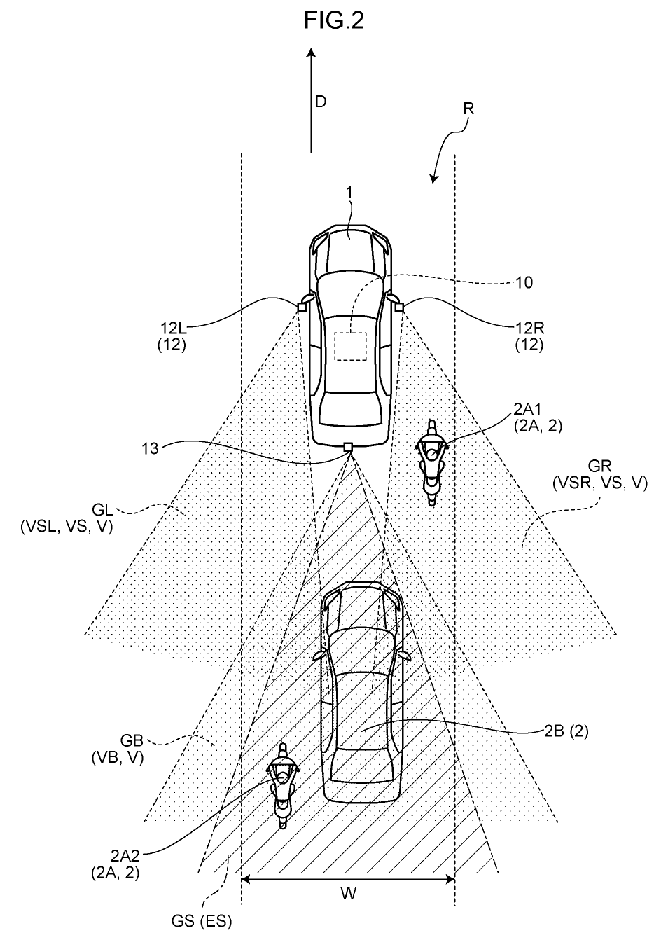

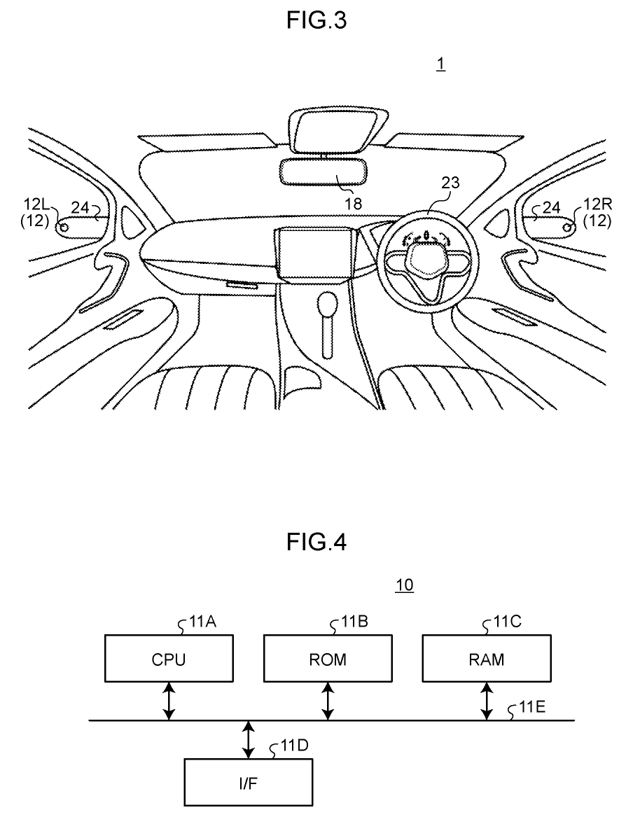

FIG. 2 is a schematic diagram of an example of a travel environment of the own vehicle 1. FIG. 3 is a schematic diagram illustrating a state in which a vehicle interior of the own vehicle 1 is visually recognized on the vehicle front side.

The rear side imaging unit 12 images the left rear side and the right rear side of the own vehicle 1, and obtains rear side images VS which are images V of the rear on the left and right sides of the own vehicle 1. The rear side imaging unit 12 includes a right rear side imaging unit 12R and a left rear side imaging unit 12L.

The right rear side imaging unit 12R is the rear side imaging unit 12 having a rear side on the right side of the own vehicle 1 as an imaging region. In the right rear side imaging unit 12R, an imaging angle of view, an installation position, an imaging direction, and the like are adjusted in advance so as to be able to image the right rear side of the own vehicle 1 in the periphery of the own vehicle 1. Specifically, the right rear side imaging unit 12R has an imaging optical axis (lens) directed to the right rear of the own vehicle 1, and images a part of the right rear and the right side of the own vehicle 1. The right rear side imaging unit 12R is provided, for example, on a side mirror 24 disposed on the right side with respect to a steering 23 of the own vehicle 1.

The right rear side imaging unit 12R has no mechanism for changing the direction of the imaging optical axis as an example, and the lens has a fixed focus and a relatively wide imaging angle of view. Therefore, the right rear side imaging unit 12R images an imaging region GR having a relatively wide angle and a constant imaging angle of view on the right rear of the own vehicle 1, and obtains a right rear side image VSR which is a captured image of the imaging region GR. The right rear side image VSR is a rear side image VS captured by the right rear side imaging unit 12R of the rear side imaging unit 12. The rear side image VS is an example of image V captured by the rear side imaging unit 12 and the rear imaging unit 13.

The left rear side imaging unit 12L is the rear side imaging unit 12 having a rear side on the left side of the own vehicle 1 as an imaging region. In the left rear side imaging unit 12L, an imaging angle of view, an installation position, an imaging direction, and the like are adjusted in advance so as to be able to image the left rear side of the own vehicle 1 in the periphery of the own vehicle 1. Specifically, the left rear side imaging unit 12L has an imaging optical axis (lens) directed to the left rear of the own vehicle 1, and images a part of the left rear and the left side of the own vehicle 1. The left rear side imaging unit 12L is provided, for example, on a side mirror 24 disposed on the left side with respect to the steering 23 of the own vehicle 1.

The left rear side imaging unit 12L has no mechanism for changing the direction of the imaging optical axis as an example, and the lens has a fixed focus and a relatively wide imaging angle of view. Therefore, the left rear side imaging unit 12L images an imaging region GL having a relatively wide angle and a constant imaging angle of view on the left rear of the own vehicle 1, and obtains a left rear side image VSL which is a captured image of the imaging region GL. The left rear side image VSL is a rear side image VS captured by the left rear side imaging unit 12L of the rear side imaging unit 12.

The rear imaging unit 13 is an imaging unit having a rear side with respect to the own vehicle 1 in the periphery of the own vehicle 1 as an imaging region. In the rear imaging unit 13, an imaging angle of view, an installation position, an imaging direction, and the like are adjusted in advance so as to be able to image the rear of the own vehicle 1 in the periphery of the own vehicle 1. Specifically, the rear imaging unit 13 has an imaging optical axis (lens) directed to the rear of the own vehicle 1, and images the rear of the own vehicle 1.

For example, the rear imaging unit 13 is disposed in the rear portion of the trunk lid of the own vehicle 1, and the imaging optical axis (lens) is directed to the rear of the own vehicle 1 to image the rear of the own vehicle 1. Additionally, the rear imaging unit 13 may be disposed near the rear bumper of the own vehicle 1 or may be disposed so as to image the rear of the own vehicle 1 through the rear windshield glass as long as the rear of the rear imaging unit 13 can be imaged. The rear imaging unit 13 has a lens as a fixed focus, is not provided with a mechanism for changing the direction of the imaging optical axis, images an imaging region GB having a constant angle of view, and obtains a rear image VB which is a captured image of the imaging region GB. The rear image VB is an example of the image V captured by the rear side imaging unit 12 and the rear imaging unit 13.

Returning to FIG. 1, the description will be continued.

The sensor 14 is mounted on the own vehicle 1, and detects each situation inside and outside the own vehicle 1. The sensor 14 includes an external sensor and an internal sensor.

The external sensor is mounted on the own vehicle 1 and detects a situation outside the own vehicle 1. In the present embodiment, the external sensor detects the presence or absence of an other vehicle 2, the distance to the other vehicle 2, and the like. The external sensor is, for example, a distance sensor, a sonar sensor that detects an object by a sound wave, an ultrasonic sensor, or the like. The distance sensor is, for example, a millimeter wave radar, a laser sensor, or the like. The laser sensor is, for example, a two-dimensional laser imaging detection and ranging (LiDAR) sensor or a three-dimensional LiDAR sensor installed in parallel with a horizontal plane. In the present embodiment, the external sensor is disposed at a position where the external sensor can detect the other vehicle 2 present on at least the rear side of the own vehicle 1. Note that the external sensors may be adjusted in advance so as to be able to detect at least the other vehicle 2 on the rear side of the own vehicle 1, and the number and arrangement positions of the external sensors provided in the own vehicle 1 are not limited.

The internal sensor is a sensor that detects the state of the own vehicle 1. The internal sensor detects a position, a speed, an acceleration, an accelerator opening, a steering angle of a steering device, a depression amount of a brake pedal, and the like of the own vehicle 1. The internal sensor includes, for example, a global positioning system (GPS), a speed sensor, an acceleration sensor such as an inertial measurement unit (IMU) that detects at least acceleration acting in the front-rear direction of the own vehicle 1, an accelerator opening sensor that detects an accelerator opening, a steering angle sensor that detects a steering angle of a steering device, a sensor that detects a depression amount of a brake pedal, and the like.

The UI unit 15 is a user interface that performs operation input by a user and information output to the user. The UI unit 15 includes, for example, an image and audio output function, a function of receiving an operation instruction by the user, and the like. The output function is, for example, a combination meter device that performs notification to the driver by display, a touch panel, and a notification sound generation device such as a buzzer or a speaker that performs notification by voice. The UI unit 15 may constitute a part of a human machine interface (HMI) or an in-vehicle infotainment (IVI).

The travel control unit 16 is an engine control unit (ECU) that controls travel of the own vehicle 1. The travel control unit 16 executes control of a drive device such as an engine or a motor of the own vehicle 1 and control of a transmission system device such as a transmission of the own vehicle 1 according to operation information by a passenger received from the operation unit 17, a detection result of the sensor 14, and the like.

The operation unit 17 is operated by the passenger of the own vehicle 1. The operation unit 17 includes, for example, an ignition switch, a shift lever, the steering 23, a direction indicator, an accelerator pedal, a brake pedal, and the like. Note that the operation unit 17 mounted on the own vehicle 1 is not limited thereto.

The travel control unit 16 controls the drive device and the transmission system device of the own vehicle 1 according to operation information of an ignition switch, shift position information of a shift lever, operation information of a direction indicator, a steering angle represented by a steering operation amount, accelerator pedal operation information of an accelerator pedal, brake pedal information of a brake pedal, and the like.

The electronic mirror 18 is a device that projects image V around the own vehicle 1 on a mirror surface. The electronic mirror 18 may be referred to as a smart rear-view mirror (SRVM), a smart room mirror, an intelligent room mirror, or the like depending on the manufacturer of the own vehicle 1 or the like. The electronic mirror 18 is an example of a display device.

As illustrated in FIG. 3, the electronic mirror 18 is provided on the vehicle upper side of the front windshield glass and substantially at the center in the vehicle width direction of the own vehicle 1. The electronic mirror 18 includes, for example, a liquid crystal panel or the like, and is capable of displaying the image V toward the vehicle interior side of the own vehicle 1. On the electronic mirror 18, the video V captured by at least one of rear side imaging unit 12 and the rear imaging unit 13 is displayed by processing to be described later. The electronic mirror 18 functions as a substitute for an inner mirror that is an optical mirror, and the driver can check the situation around the own vehicle 1 centered on the rear of the own vehicle 1 by visually recognizing the image V displayed on the electronic mirror 18.

Returning to FIG. 1, the description will be continued.

The storage unit 19 stores various data. At least a part of the data included in the storage unit 19 may be stored in an external storage device communicably connected to the information processing apparatus 10.

Next, the information processing apparatus 10 will be described in detail.

FIG. 4 is a hardware configuration diagram of an example of the information processing apparatus 10.

In the information processing apparatus 10, a central processing unit (CPU) 11A, a read only memory (ROM) 11B, a random access memory (RAM) 11C, an interface (I/F) 11D are connected to each other by a bus 11E, and a hardware configuration using a normal computer is adopted.

The CPU 11A is an arithmetic device that controls the information processing apparatus 10 of the present embodiment. The ROM 11B stores programs and the like for realizing various kinds of processing by the CPU 11A. The RAM 11C stores data necessary for various kinds of processing by the CPU 11A. The I/F 11D is an interface for transmitting and receiving data.

The information processing apparatus 10 may be realized by a computer such as an electronic control unit (ECU) provided inside the own vehicle 1, a domain control unit (DCU) such as a cockpit domain controller (CDC) in which a plurality of ECUs is integrated, or an on-board unit (OBU). In this case, the information processing apparatus 10 may transmit and receive information to and from another ECU mounted on the own vehicle 1 or a device connected to the own vehicle 1 via an in-vehicle network including a controller area network (CAN), Ethernet (registered trademark), a universal serial bus (USB (registered trademark)), or the like in the own vehicle 1, or may communicate with an information processing apparatus outside the own vehicle 1 via a network such as the Internet. Furthermore, the information processing apparatus 10 according to the embodiment may be realized by a single ECU or the like, or may be realized by another ECU, a DCU, or an OBU that realizes control of each function of the own vehicle 1 such as power steering control, accelerator control, brake control, another charge control, or automatic driving control, or may be realized by cooperation thereof.

The information processing apparatus 10 is not limited to the CPU 11A, and may include various processors such as a graphics processing unit (GPU), an application specific integrated circuit (ASIC), and a field programmable gate array (FPGA).

Furthermore, the information processing apparatus 10 may include various recording media and recording devices such as a hard disk drive (HDD), a solid-state drive (SSD), and a flash memory as the auxiliary storage device.

A program for executing the above-described various processing executed by the information processing apparatus 10 is provided by being incorporated in the ROM 11B or the like in advance. The program for executing the vehicle control method executed in the present embodiment may be provided by being recorded in a computer-readable computer program product such as a CD-ROM, a flexible disk (FD), a CD-R, or a digital versatile disc (DVD) as a file in a format installable or executable in these devices.

Furthermore, the program executed by the information processing apparatus 10 according to the present embodiment may be configured to be stored in a computer connected to a network such as the Internet and provided by being downloaded via the network. In addition, the program executed by the information processing apparatus 10 according to the present embodiment may be configured to be provided or distributed via a network such as the Internet.

In addition, the program executed by the information processing apparatus 10 of the present embodiment may be configured to be provided or distributed by being incorporated in advance in the ROM 11B or the like.

For example, at least one processor (for example, the CPU 11A) of the information processing apparatus 10 loads a program stored in the auxiliary storage device (for example, the ROM 11B) into the main storage device (for example, the RAM 11C) and executes the loaded program, thereby implementing each function of the information processing apparatus 10. Note that at least one processor of the information processing apparatus 10 may be configured as a dedicated hardware circuit.

Returning to FIG. 1, the description will be continued.

The information processing apparatus 10 includes a processing unit 22. The processing unit 22 executes various types of information processing. For example, the CPU 11A reads the program from the ROM 11B onto the RAM 11C and executes the program, whereby each functional unit to be described later of the processing unit 22 is realized on the computer.

The processing unit 22 includes an acquisition unit 22A, a traveling status deriving unit 22B, and a display control unit 22C. Some or all of the acquisition unit 22A, the traveling status deriving unit 22B, and the display control unit 22C may be realized, for example, by causing a processing device such as the CPU 11A to execute a program, that is, by software, may be realized by hardware such as an integrated circuit (IC), or may be realized by using software and hardware in combination. Furthermore, at least one of the acquisition unit 22A, the traveling status deriving unit 22B, and the display control unit 22C may be configured to be mounted on an external information processing apparatus communicably connected to the information processing apparatus 10 via a network or the like.

The acquisition unit 22A acquires the image V from the rear side imaging unit 12 and the rear imaging unit 13. Specifically, the acquisition unit 22A acquires the right rear side image VSR from the right rear side imaging unit 12R, acquires the left rear side image VSL from the left rear side imaging unit 12L, and acquires the rear image VB from the rear imaging unit 13. In addition, the acquisition unit 22A acquires a detection result by the sensor 14. In addition, the travel control unit 16 acquires information indicating travel control details by the travel control unit 16.

The traveling status deriving unit 22B derives the traveling status of the own vehicle 1.

The traveling status is information indicating at least one of the type of the other vehicle 2 included in each of the rear image VB and the rear side image VS, road width W of a traveling road R of the own vehicle 1 (see also FIG. 2), the vehicle speed of the own vehicle 1, the inter-vehicle distance between the own vehicle 1 and the other vehicle 2 traveling following the own vehicle 1, the total number of the other vehicles 2 appearing in the rear image VB, the type of the adjacent regions adjacent to the lane of the own vehicle 1, the relative speed between the own vehicle 1 and the detected two-wheeled vehicle 2A, the distance between the own vehicle 1 and the detected two-wheeled vehicle 2A, whether or not the other vehicle 2 appearing in the rear image VB is a vehicle requiring caution, the position of the vehicle requiring caution appearing in the rear image VB, and whether or not the own vehicle 1 is in a state where a change of the lane or a right/left turn is impossible.

The type of the other vehicle 2 represents either the two-wheeled vehicle 2A or a four-wheeled vehicle 2B. The traveling status deriving unit 22B analyzes each of the rear image VB and the rear side image VS by a known method using artificial intelligence (AI) trained by pattern matching, deep learning, or the like, thereby identifying the other vehicle 2 appearing in each of the rear image VB and the rear side image VS and identifying the type of the other vehicle 2.

The road width W of the traveling road R of the own vehicle 1 represents the width of the road on which the own vehicle 1 is traveling (see FIG. 2). Note that the road width W of the traveling road R of the own vehicle 1 may be any of the width of the lane in which the own vehicle 1 is traveling and the total width of the lane in which the own vehicle 1 is traveling and another lane arranged adjacent to the lane of the own vehicle 1 and extending in the same direction as the extending direction of the lane of the own vehicle 1.

The traveling status deriving unit 22B may derive the road width W of the traveling road R of the own vehicle 1 by a known method using the detection result of the sensor 14, the image V, and the like. In addition, the road width W may be derived by acquiring the road width W of the traveling road R of the own vehicle 1 from the travel control unit 16 via the CAN or the like. In addition, the traveling status deriving unit 22B may derive the road width W of the traveling road R of the own vehicle 1 by receiving the road width W of the traveling road R derived using map data or the like from an external information processing apparatus or the like via the communication unit 11.

The vehicle speed of the own vehicle 1 means a current vehicle speed of the own vehicle 1. The traveling status deriving unit 22B acquires the vehicle speed of the own vehicle 1 detected by the internal sensor to identify the vehicle speed of the own vehicle 1. In addition, the traveling status deriving unit 22B may identify the vehicle speed of the own vehicle 1 by acquiring the vehicle speed of the own vehicle 1 from the travel control unit 16 via CAN or the like.

The inter-vehicle distance between the own vehicle 1 and the other vehicle 2 traveling following the own vehicle 1 means an inter-vehicle distance between the own vehicle 1 and the other vehicle 2 traveling closest to the rear of the own vehicle 1 among the other vehicles 2 traveling following the own vehicle 1. The other vehicles 2 traveling following the own vehicle 1 are the other vehicles 2 appearing in the rear image VB.

The traveling status deriving unit 22B identifies, as an inter-vehicle distance from the own vehicle 1 to the other vehicle 2, the shortest distance between the own vehicle 1 and the other vehicle 2 detected by an external sensor having a range including the imaging region GB of the rear image VB as a detection range. In addition, for example, the traveling status deriving unit 22B may derive the distance from the own vehicle 1 to the other vehicle 2 traveling following the own vehicle 1 as the inter-vehicle distance by estimating the distance in a pseudo manner from the foot position, the width, and the like of an object by a known method by a combination of the rear image VB and object detection using AI or the like trained by deep learning or the like. Furthermore, for example, the traveling status deriving unit 22B may calculate a difference between the position of the own vehicle 1 detected by the internal sensor and the position of the other vehicle 2 received from the other vehicle 2 by vehicle-to-vehicle communication or the like as the inter-vehicle distance between the own vehicle 1 and the other vehicle 2.

The total number of the other vehicles 2 appearing in the rear image VB is the total number of all other vehicles 2 appearing in the rear image VB.

The traveling status deriving unit 22B derives the total number of the other vehicles 2 appearing in the rear image VB by a combination of the rear image VB and the object detection using AI or the like trained by deep learning or the like. In addition, the traveling status deriving unit 22B may derive the total number of the other vehicles 2 appearing in the rear image VB by acquiring the total number of the other vehicles 2 present in the imaging region GB of the rear image VB of the own vehicle 1 from the travel control unit 16 via the CAN or the like. In addition, the traveling status deriving unit 22B may derive the total number of the other vehicles 2 appearing in the rear image VB by receiving information from the other vehicles 2 existing in the imaging region GB by vehicle-to-vehicle communication or the like.

The type of the adjacent region adjacent to the lane of the own vehicle 1 is information indicating whether the region adjacent to the traveling road R of the own vehicle 1 is a region where traveling of the vehicle is prohibited or difficult or a region where traveling of the vehicle is permitted or allowed. The region where the traveling of the vehicle is prohibited or difficult is, for example, a sidewalk. The region where the traveling of the vehicle is permitted or allowed is, for example, a roadway. In the present embodiment, a form in which the type of the adjacent region is a roadway or a sidewalk will be described as an example.

The traveling status deriving unit 22B derives whether a region adjacent to the traveling road R of the own vehicle 1 is a roadway or a sidewalk by a combination of the rear side image VS, the rear image VB, and region detection using AI or the like trained by deep learning or the like. In addition, for example, the traveling status deriving unit 22B may derive whether the adjacent region is a roadway or a sidewalk by acquiring the type of the adjacent region of the own vehicle 1 from the travel control unit 16 via CAN or the like. Furthermore, for example, the traveling status deriving unit 22B may derive whether the type of the adjacent region adjacent to the lane of the own vehicle 1 is a roadway or a sidewalk by receiving the type of the adjacent region of the own vehicle 1 derived using map data or the like from an external information processing apparatus or the like via the communication unit 11.

The relative speed between the own vehicle 1 and the detected two-wheeled vehicle 2A represents the relative speed of the detected two-wheeled vehicle 2A with respect to the own vehicle 1. The detected two-wheeled vehicle 2A is the two-wheeled vehicle 2A that is reflected in the rear side image VS and is not reflected in the rear image VB. Specifically, the detected two-wheeled vehicle 2A is a two-wheeled vehicle 2A that satisfies a first condition to be described later. In the state illustrated in FIG. 2, the detected two-wheeled vehicle 2A is a two-wheeled vehicle 2A1 out of the two-wheeled vehicle 2A1 and the two-wheeled vehicle 2A2 traveling around the own vehicle 1. For example, the traveling status deriving unit 22B derives the relative speed of the two-wheeled vehicle 2A with respect to the own vehicle 1 by a known method from a change in at least one of the position and the size of the two-wheeled vehicle 2A in the rear side image VS. In addition, the traveling status deriving unit 22B may derive the relative speed using the speed of the own vehicle 1 detected by the internal sensor of the own vehicle 1 and the speed of the two-wheeled vehicle 2A acquired from the two-wheeled vehicle 2A by vehicle-to-vehicle communication.

The detected distance to the two-wheeled vehicle 2A represents an inter-vehicle distance to the two-wheeled vehicle 2A detected with respect to the own vehicle 1. The definition of the detected two-wheeled vehicle 2A is the same as described above. The traveling status deriving unit 22B identifies, as a distance from the own vehicle 1 to the two-wheeled vehicle 2A, the shortest distance between the own vehicle 1 and the two-wheeled vehicle 2A detected by an external sensor having a range including at least one of the imaging region GL of the rear side image VS and the imaging region GR as a detection range. In addition, for example, the traveling status deriving unit 22B may derive the distance from the own vehicle 1 to the two-wheeled vehicle 2A by estimating the distance in a pseudo manner from the foot position, the width, and the like of the two-wheeled vehicle 2A by a known method by a combination of the rear side image VS and object detection using AI or the like trained by deep learning or the like. Furthermore, for example, the traveling status deriving unit 22B may calculate a difference between the position of the own vehicle 1 detected by the internal sensor and the position of the two-wheeled vehicle 2A received from the two-wheeled vehicle 2A by vehicle-to-vehicle communication or the like as the distance between the own vehicle 1 and the two-wheeled vehicle 2A.

Whether or not the other vehicle 2 appearing in the rear image VB is a vehicle requiring caution is information indicating whether or not the other vehicle 2 appearing in the rear image VB is a predetermined vehicle requiring caution. The vehicle requiring caution is the other vehicle 2 that may need to be paid attention by the driver of the own vehicle 1. The vehicle requiring caution is, for example, an emergency vehicle such as a fire engine or an ambulance, a tailgating vehicle, or the like.

The traveling status deriving unit 22B may store in advance feature information indicating the feature of a vehicle requiring caution and identify the other vehicle 2 that matches or is similar to the feature information among the other vehicles 2 appearing in the rear image VB as a vehicle requiring caution. In addition, the traveling status deriving unit 22B may derive whether or not the other vehicle 2 appearing in the rear image VB is a vehicle requiring caution by analyzing the rear image VB by a known method.

The position in the rear image VB of the vehicle requiring caution appearing in the rear image VB represents the position in the rear image VB of the vehicle requiring caution appearing in the rear image VB. The traveling status deriving unit 22B may identify the position of the vehicle requiring caution appearing in the rear image VB in the rear image VB.

A state in which the own vehicle 1 cannot change the lane or turn right or left represents, for example, a state in which the traveling road R of the own vehicle 1 is one lane on one side or the like, and it is difficult to enter another traveling road, a parking lot, or the like by turning right or left, or to change the lane. The traveling status deriving unit 22B derives whether the own vehicle 1 is in a state where a change of the lane or a right/left turn is impossible by a combination of the rear side image VS, the rear image VB, and region detection using AI or the like trained by deep learning or the like. In addition, for example, the traveling status deriving unit 22B may derive whether the own vehicle 1 is in a state where a change of the lane or a right/left turn is impossible by acquiring a situation around the own vehicle 1 from the travel control unit 16 via CAN or the like. In addition, for example, the traveling status deriving unit 22B may derive information indicating whether or not the own vehicle 1 is in a state where a change of the lane or a right/left turn is impossible derived using map data or the like from an external information processing apparatus or the like via the communication unit 11.

Next, the display control unit 22C will be described.

The display control unit 22C displays, on the electronic mirror 18, the rear image VB captured by the rear imaging unit 13 that images the rear of the own vehicle 1. As described above, the electronic mirror 18 is an example of a display device.

In addition, when satisfying the first condition, the display control unit 22C displays the second display image in which the rear side image VS is superimposed on a part of the rear image VB on the electronic mirror 18.

The first condition represents a case where there exists the two-wheeled vehicle 2A that does not appear in the rear image VB but appears in the rear side image VS captured by the rear side imaging unit 12 that images the left rear side and the right rear side of the own vehicle 1.

Appearing in the rear side image VS captured by the rear side imaging unit 12 that images the left rear side and the right rear side of the own vehicle 1 means appearing in any one of the left rear side image VSL captured by the left rear side imaging unit 12L and the right rear side image VSR captured by the right rear side imaging unit 12R.

Description will be given with reference to FIG. 2. In the situation illustrated in FIG. 2, in the two-wheeled vehicle 2A1 and the two-wheeled vehicle 2A2 which are the two-wheeled vehicle 2A existing on the rear and the rear side of the own vehicle 1, the two-wheeled vehicle 2A1 is not included in the imaging region GB of the rear imaging unit 13, but is included in the imaging region GL of the left rear side imaging unit 12L. Therefore, the two-wheeled vehicle 2A1 is not appearing in the rear side image VS captured by the rear imaging unit 13, but appearing in the left rear side image VSL captured by the left rear side imaging unit 12L. Therefore, the situation illustrated in FIG. 2 is a situation in which the first condition is satisfied. In other words, the two-wheeled vehicle 2A1 is the two-wheeled vehicle 2A that satisfies the first condition.

On the other hand, since the two-wheeled vehicle 2A2 is included in the imaging region GB of the rear imaging unit 13, the two-wheeled vehicle 2A2 is appearing in the rear image VB captured by the rear imaging unit 13. Therefore, the two-wheeled vehicle 2A2 is the two-wheeled vehicle 2A that does not satisfy the first condition.

If there exists the two-wheeled vehicle 2A satisfying the first condition, the display control unit 22C displays the second display image in which the rear side image VS is superimposed on a part of the rear image VB on the electronic mirror 18.

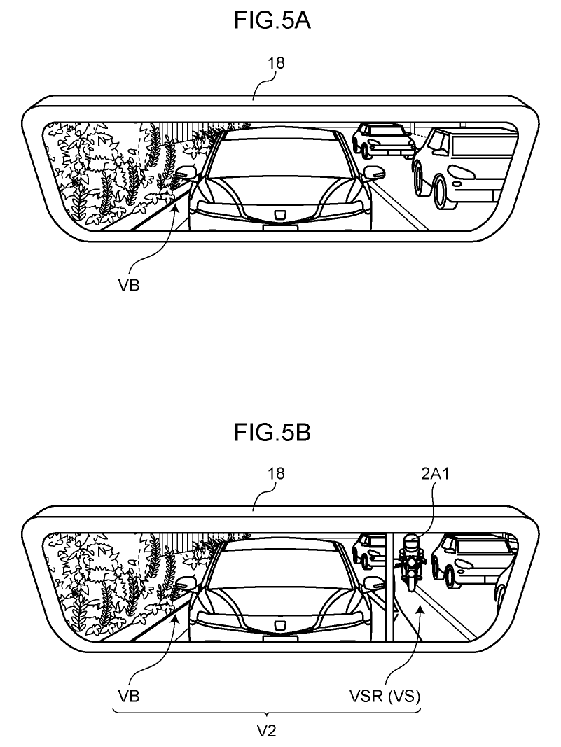

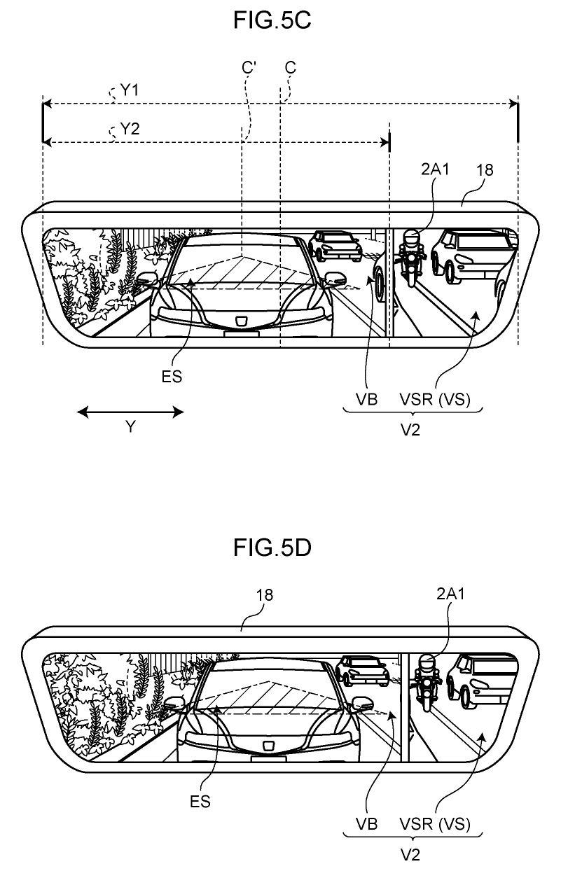

FIG. 5A and 5B are schematic diagrams of an example of the image V displayed on the electronic mirror 18.

FIG. 5A illustrates an example of a state in which rear side image VS is not displayed and only the rear image VB is displayed on the electronic mirror 18. FIG. 5B illustrates an example of a state in which a second display image V2 is displayed on the electronic mirror 18.

If there exists no two-wheeled vehicle 2A satisfying the first condition, the display control unit 22C displays only the rear image VB on the electronic mirror 18 as illustrated in FIG. 5A. On the other hand, if there exists the two-wheeled vehicle 2A (hereinafter, may be referred to as the two-wheeled vehicle 2A1) satisfying the first condition, the display control unit 22C switches the image V displayed on the electronic mirror 18 to the second display image V2.

The second display image V2 is an image in which the rear side image VS is superimposed on a part of the rear image VB.

The display control unit 22C displays the second display image V2 which is superimposed with the rear side image VS in which the two-wheeled vehicle 2A1 satisfying the first condition is appearing on a part of rear image VB on the electronic mirror 18. That is, the display control unit 22C displays, on the electronic mirror 18, the second display image V2, among the left rear side image VSL and the right rear side image VSR, which is superimposed with the rear side image VS in which the two-wheeled vehicle 2A1 satisfying the first condition is appearing on the rear image VB.

Therefore, the display control unit 22C can display, on the electronic mirror 18, the rear image VB of the rear of the own vehicle 1 with respect to the driver and the rear side image VS including the two-wheeled vehicle 2A1 on the rear side of the own vehicle 1 that is not appearing in the rear image VB in a manner allowing the driver to confirm the rear image VB and the rear side image VS.

Preferably, the display control unit 22C displays, on the electronic mirror 18, the second display image V2 in which the rear side image VS corresponding to the detected direction of the two-wheeled vehicle 2A1 is superimposed on the region corresponding to the detection direction of the two-wheeled vehicle 2A1 with respect to the own vehicle 1 in the rear image VB.

The display control unit 22C may identify the detection direction of the two-wheeled vehicle 2A1 satisfying the first condition using the analysis of the rear side image VS and the detection result by the sensor 14. In the state illustrated in FIG. 2, the two-wheeled vehicle 2A1 satisfying the first condition exists on the rear of the right side with respect to the own vehicle 1. Therefore, the display control unit 22C may display, on the electronic mirror 18, the second display image V2 in which the right rear side image VSR is superimposed on the right end in the display surface of the electronic mirror 18 when viewed from the driver of the own vehicle 1.

Therefore, the display control unit 22C can display the rear side image VS in which the two-wheeled vehicle 2A1 is appearing, which is not appearing in the rear image VB, on the detection direction side of the two-wheeled vehicle 2A1, and can make the direction in which the two-wheeled vehicle 2A1 is present easily recognizable to the driver.

In addition, preferably, the display control unit 22C displays, on the electronic mirror 18, the second display image V2 in which the rear side image VS is superimposed on the region outside the prescribed region of the prescribed view angle range in the rear image VB and corresponding to the detection direction of the two-wheeled vehicle 2A1 with respect to the own vehicle 1.

Description will be given with reference to FIG. 2.

A prescribed view angle region GS is a field of view range that needs to be confirmed by the driver with a rear-view mirror or the like defined for each vehicle type category. Specifically, the prescribed view angle region GS is a range that satisfies the definition related to the field of view of the Regulation No. 46 (UN-R46: United Nations-Regulation46). The definition related to the field of view of the UN-R46 is a convention regulation related to the standard of indirect vision defined by the United Nations, and is "The field of vision shall be such that the driver can see at least a 20 m wide, flat, horizontal portion of the road centered on the vertical longitudinal median plane of the vehicle and extending from 60 m behind the driver's ocular points to the horizon".

The display control unit 22C displays, on the electronic mirror 18, a second display image V2 in which a rear side image VS (a right rear side image VSR in the situation of FIG. 2) in which the two-wheeled vehicle 2A1 is appearing is superimposed on a region outside a prescribed region ES of the prescribed view angle region GS in the rear image VB of the imaging region GB of the rear imaging unit 13 and corresponding to the detection direction of the two-wheeled vehicle 2A1 with respect to the own vehicle 1.

FIGS. 5C and 5D are schematic diagrams of an example of the second display image V2 displayed on the electronic mirror 18.

As illustrated in FIG. 5C, the display control unit 22C displays, on the electronic mirror 18, the second display image V2 in which the right rear side image VSR in which the two-wheeled vehicle 2A1 is appearing is superimposed on a region outside the prescribed region ES of the prescribed view angle region GS in the rear image VB and corresponding to the detection direction of the two-wheeled vehicle 2A1 with respect to the own vehicle 1. Therefore, the prescribed region ES in the rear image VB is displayed on the electronic mirror 18, and the right rear side image VSR including the two-wheeled vehicle 2A1 satisfying the first condition is displayed in the detection direction of the two-wheeled vehicle 2A1.

Therefore, the prescribed region ES in the rear image VB is prevented from being non-displayed due to the superimposition of the rear side image VS in which the two-wheeled vehicle 2A1 is appearing. In other words, the display control unit 22C can display, on the electronic mirror 18, the rear image VB including at least the prescribed region ES of the rear of the own vehicle 1 and the rear side image VS in which the two-wheeled vehicle 2A1 not appearing in the rear image VB is appearing in a manner allowing the driver to confirm the rear image VB and the rear side image VS. That is, the display control unit 22C can display the two-wheeled vehicle 2A1 existing in the rear side image VS in such a manner that the driver can easily confirm the two-wheeled vehicle 2A1 while complying with the Regulation No. 46.

Note that the display control unit 22C may arrange the center C' of the rear image VB at a position shifted from the center C of the display region of the electronic mirror 18, and display, on the electronic mirror 18, the display second display image V2 in which the rear side image VS in which the two-wheeled vehicle 2A1 satisfying the first condition is appearing is superimposed outside the prescribed region ES of the rear image VB. The center C' of the rear image VB means the center of the rear image VB in the width direction Y. Specifically, the center C' of the rear image VB means a center position in the width direction Y2 of the rear image VB in the rear image VB. The center C of the display region of the electronic mirror 18 means the center of the display region of the electronic mirror 18 in the width direction Y. Specifically, the center C of the display region of the electronic mirror 18 means a center position in width direction Y1 of the electronic mirror 18 on the display surface of the electronic mirror 18. The width direction Y, the width direction Y1, and the width direction Y2 correspond to the vehicle width direction of the own vehicle 1.

The display control unit 22C displays the rear side image VS in which the two-wheeled vehicle 2A1 is appearing by arranging the center C' of the rear image VB at the position shifted from the center C of the display region of the electronic mirror 18, and thus, it is possible to suppress the non-display of at least a part of the prescribed region ES included in the rear image VB due to the superimposed display of the rear side image VS.

As illustrated in FIG. 5D, the display control unit 22C may display, on the electronic mirror 18, the second display image V2 obtained by cutting out, from the rear side image VS, a region including the two-wheeled vehicle 2A1 that satisfies the first condition and is appearing in the rear side image VS, and superimposing the cutout region onto a region outside the prescribed region ES in the rear image VB.

The display control unit 22C cuts out a region including the two-wheeled vehicle 2A1 appearing in the rear side image VS and superimposes the cutout region onto the rear image VB, and thus, it is possible to suppress the non-display of at least a part of the prescribed region ES included in the rear image VB due to the superimposed display of the rear side image VS in which the two-wheeled vehicle 2A1 is appearing.

Returning to FIG. 2, the description will be continued.

If the first condition is satisfied and the second condition is satisfied, the display control unit 22C may display the second display image V2 on the electronic mirror 18.

The second condition represents at least one of the road width W of the traveling road R of the own vehicle 1 being larger than or equal to the first width, the vehicle speed of the own vehicle 1 being less than the first speed, the inter-vehicle distance between the own vehicle 1 and the other vehicle 2 traveling following the own vehicle 1 being less than the first distance, the total number of the other vehicles 2 appearing in the rear image VB being larger than or equal to the first predetermined number, and the adjacent region adjacent to the lane of the own vehicle 1 being not a roadway and the vehicle speed of the own vehicle 1 being less than the second speed.

For example, if the first condition is satisfied and the road width W of the traveling road R of the own vehicle 1 is greater than or equal to the first width, the display control unit 22C switches the display on the electronic mirror 18 from the rear image VB to the second display image V2.

The first width may be the minimum width of the traveling road R that allows the two-wheeled vehicle 2A1 to pass through the side of the own vehicle 1 traveling on the traveling road R and overtake the own vehicle 1. The first width may be set in advance according to the vehicle width of the own vehicle 1. Furthermore, the first width may be appropriately changeable in accordance with an operation instruction or the like of the UI unit 15 or the like by the user.

The display control unit 22C may determine whether or not the road width W of the traveling road R of the own vehicle 1 derived by the traveling status deriving unit 22B is larger than or equal to the first width. Then, when determining that the first condition is satisfied and the road width W of the traveling road R of the own vehicle 1 is greater than or equal to the first width, the display control unit 22C switches the display on the electronic mirror 18 from the rear image VB to the second display image V2. By the switching processing of the display from the rear image VB to the second display image V2, if the two-wheeled vehicle 2A1 that does not appear in the rear image VB but appears in the rear side image VS is likely to pass through the side of the own vehicle 1 and travel, the display control unit 22C can display, on the electronic mirror 18, the second display image V2 in which the rear side image VS in which the two-wheeled vehicle 2A1 appears is superimposed on the rear image VB.

In addition, if the first condition is satisfied and the vehicle speed of the own vehicle 1 is less than the first speed, the display control unit 22C switches the display on the electronic mirror 18 from the rear image VB to the second display image V2.

The first speed may be the maximum speed of the own vehicle 1 at which the two-wheeled vehicle 2A1 can pass through the side of the own vehicle 1 and overtake the own vehicle 1. The first speed may be set in advance according to the possible travelling speed of the own vehicle 1. Furthermore, the first speed may be appropriately changeable in accordance with an operation instruction or the like of the UI unit 15 or the like by the user.

The display control unit 22C may determine whether or not the vehicle speed of the own vehicle 1 derived by the traveling status deriving unit 22B is less than the first speed. Then, when determining that the first condition is satisfied and the vehicle speed of the own vehicle 1 is less than the first speed, the display control unit 22C switches the display on the electronic mirror 18 from the rear image VB to the second display image V2. By the switching processing of the display from the rear image VB to the second display image V2, if the two-wheeled vehicle 2A1 that does not appear in the rear image VB but appears in the rear side image VS is likely to pass through the side of the own vehicle 1 and travel to overtake the own vehicle 1, the display control unit 22C can display, on the electronic mirror 18, the second display image V2 in which the rear side image VS in which the two-wheeled vehicle 2A1 appears is superimposed on the rear image VB.

In addition, if the first condition is satisfied and the inter-vehicle distance between the own vehicle 1 and the other vehicle 2 traveling following the own vehicle 1 is less than the first distance, the display control unit 22C switches the display on the electronic mirror 18 from the rear image VB to the second display image V2.

The first distance may be the maximum distance at which the other vehicle 2 traveling following the own vehicle 1 largely appears in the rear image VB, so that the other vehicles 2 other than the above-described other vehicle 2 don't appear in the rear image VB. The first distance may be set in advance. Furthermore, the first distance may be appropriately changeable in accordance with an operation instruction or the like of the UI unit 15 or the like by the user.

The display control unit 22C may determine whether or not the inter-vehicle distance between the own vehicle 1 and the other vehicle 2 traveling following the own vehicle 1 derived by the traveling status deriving unit 22B is less than the first distance. Then, if the first condition is satisfied and the inter-vehicle distance between the own vehicle 1 and the other vehicle 2 traveling following the own vehicle 1 is less than the first distance, the display control unit 22C switches the display on the electronic mirror 18 from the rear image VB to the second display image V2. By the switching processing of the display from the rear image VB to the second display image V2, the display control unit 22C can prevent the two-wheeled vehicle 2A, which is likely to pass through the side of the own vehicle 1 and travel, from being hidden by the other vehicle 2 traveling following the own vehicle 1 closest to the own vehicle 1, so that the two-wheeled vehicle 2A is not confirmed by the driver.

In addition, if the first condition is satisfied and the total number of the other vehicles 2 appearing in the rear image VB is larger than or equal to the first predetermined number, the display control unit 22C switches the display on the electronic mirror 18 from the rear image VB to the second display image V2.

The first predetermined number may be the minimum number in which the two-wheeled vehicle 2A1 satisfying the first condition is likely to be buried in the other vehicle 2 due to a large number of other vehicles 2 traveling following the own vehicle 1. The first predetermined number may be set in advance. Furthermore, the first predetermined number may be appropriately changeable in accordance with an operation instruction or the like of the UI unit 15 or the like by the user.

The display control unit 22C may determine whether or not the total number of the other vehicles 2 appearing in the rear image VB derived by the traveling status deriving unit 22B is larger than or equal to the first predetermined number. Then, if the first condition is satisfied and the total number of the other vehicles 2 appearing in the rear image VB is larger than or equal to the first predetermined number, the display control unit 22C switches the display on the electronic mirror 18 from the rear image VB to the second display image V2. By the switching processing of the display from the rear image VB to the second display image V2, the display control unit 22C can prevent at least a part of the two-wheeled vehicle 2A travelling around the own vehicle 1 from being hidden by a large number of the other vehicles 2 traveling following the own vehicle 1 and being not confirmed by the driver.

In addition, if the first condition is satisfied and the adjacent region adjacent to the lane of the own vehicle 1 is not a roadway and the vehicle speed of the own vehicle 1 is less than the second speed, the display control unit 22C switches the display on the electronic mirror 18 from the rear image VB to the second display image V2.

The second speed may be the maximum speed of a speed after the own vehicle 1 decelerates for traveling requiring caution, a speed when turning right, or a speed when turning left. The second speed may be set in advance. Furthermore, the second speed may be appropriately changeable in accordance with an operation instruction or the like of the UI unit 15 or the like by the user.

The display control unit 22C may determine whether or not the type of the adjacent region adjacent to the lane of the own vehicle 1 is a sidewalk and the vehicle speed of the own vehicle 1 is less than the second speed, which are derived by the traveling status deriving unit 22B. Then, if the first condition is satisfied and the adjacent region adjacent to the lane of the own vehicle 1 is not a roadway but a sidewalk and the vehicle speed of the own vehicle 1 is less than the second speed, the display control unit 22C switches the display on the electronic mirror 18 from the rear image VB to the second display image V2. By the switching processing of the display from the rear image VB to the second display image V2, when the own vehicle 1 decelerates to less than the second speed in order to enter the adjacent region that is not the roadway, the display control unit 22C can provide the rear image VB and provide the two-wheeled vehicle 2A1 that is highly likely to pass through the side of the own vehicle 1 so as to be visually recognizable to the driver.

Thus, if the first condition is satisfied and the second condition is satisfied, the display control unit 22C preferably displays the second display image V2 on the electronic mirror 18.

In the case that the first condition and the second condition are satisfied, preferably the display control unit 22C switches the display on the electronic mirror 18 from the rear image VB to the second display image V2 in a shorter time after the determination that the first condition and the second condition are satisfied as the relative speed of the two-wheeled vehicle 2A1 that satisfies the first condition with respect to the own vehicle 1 is faster.

The display control unit 22C may switch the display on the electronic mirror 18 from the rear image VB to the second display image V2 in a shorter time from the timing when it is determined that the first condition and the second condition are satisfied, according to the relative speed between the own vehicle 1 and the two-wheeled vehicle 2A1 that satisfies the first condition, which is derived by the traveling status deriving unit 22B, as the relative speed is faster.

For example, it is assumed that the rear image VB is switched to the second display image V2 at the timing when the reference elapsed time (for example, several milliseconds) elapses from the timing when the display control unit 22C determines that the first condition and the second condition are satisfied. In this case, the display control unit 22C switches the display on the electronic mirror 18 from the rear image VB to the second display image V2 after an elapsed time shorter than the reference elapsed time from the timing when it is determined that the first condition and the second condition are satisfied as the relative speed is faster.

The display control unit 22C switches the display on the electronic mirror 18 from the rear image VB to the second display image V2 at the timing corresponding to the relative speed, so that the presence of the two-wheeled vehicle 2A1 satisfying the first condition can be provided to the user at a faster speed as the relative speed is faster. In addition, as the relative speed becomes slower, the necessity of calling attention to a faster-speed driver of the two-wheeled vehicle 2A1 satisfying the first condition becomes lower. Therefore, the display control unit 22C can provide the driver with the presence of the two-wheeled vehicle 2A1 satisfying the first condition at an appropriate timing in a manner that the driver can be alerted.

Next, switching control from the second display image V2 to the rear image VB by the display control unit 22C will be described.

When satisfying the third condition, the display control unit 22C switches the second display image V2 to the rear image VB to display the rear image VB on the electronic mirror 18. Specifically, when determining that the third condition is satisfied, the display control unit 22C switches display of the second display image V2 in which the rear side image VS in which the two-wheeled vehicle 2A1 satisfying the first condition appears is superimposed on the rear image VB illustrated in FIGS. 5B to 5C to display only the rear image VB illustrated in FIG. 5A, and displays the rear image VB on the electronic mirror 18.

The third condition is at least one of the following: the distance from the two-wheeled vehicle 2A1 appearing in the rear side image VS is changed from greater than or equal to a predetermined distance to less than the predetermined distance, and the two-wheeled vehicle 2A1 no longer appears in the rear side image VS; the road width W of the traveling road R of the own vehicle 1 is less than the first width; the vehicle speed of the own vehicle 1 is greater than or equal to the first speed; the inter-vehicle distance from the other vehicle 2 traveling following the own vehicle 1 is greater than or equal to the first distance; the other vehicle 2 appearing in the rear image VB is a predetermined vehicle requiring caution; the vehicle requiring caution appearing in the rear image VB is present in a region on which the rear side image VS is to be superimposed in the rear image VB included in the second display image V2; and the own vehicle 1 cannot change the lane or turn right or left.

For example, during the display of the second display image V2 on the electronic mirror 18, when the distance from the two-wheeled vehicle 2A1 appearing in the rear side image VS becomes less than the predetermined distance from the predetermined distance or more, and the two-wheeled vehicle 2A1 no longer appears in the rear side image VS, the display control unit 22C switches the display of the electronic mirror 18 from the second display image V2 to the rear image VB.

The predetermined distance may be set to a distance by which it can be determined that the two-wheeled vehicle 2A1 satisfying the first condition passes through the side of the own vehicle 1 and travels in front of the own vehicle 1 by completely passing the own vehicle 1. The predetermined distance is, for example, 5 m, but is not limited to this distance. The predetermined distance may be appropriately changeable in accordance with an operation instruction or the like of the UI unit 15 or the like by the user.

The display control unit 22C is only required to determine whether or not the distance to the two-wheeled vehicle 2A1 derived by the traveling status deriving unit 22B is changed from a state of being a predetermined distance or more to a state of being less than a predetermined distance, and the two-wheeled vehicle 2A1 no longer appears in the rear side image VS. Then, during the display of the second display image V2 on the electronic mirror 18, when the distance from the two-wheeled vehicle 2A1 appearing in the rear side image VS becomes less than the predetermined distance from the predetermined distance or more, and the two-wheeled vehicle 2A1 no longer appears in the rear side image VS, the display control unit 22C switches the display of the electronic mirror 18 from the second display image V2 to the rear image VB. By switching processing of the display from the second display image V2 to the rear image VB, the display control unit 22C can switch the image V to be displayed on the electronic mirror 18 from the second display image V2 to the rear image VB when the risk of the two-wheeled vehicle 2A1 satisfying the first condition to the own vehicle 1 decreases.

In addition, during the display of the second display image V2 on the electronic mirror 18, if the display control unit 22C determines that the road width W of the traveling road R of the own vehicle 1 is less than the first width, the display control unit 22C switches the display on the electronic mirror 18 from the second display image V2 to the rear image VB.

The display control unit 22C may determine whether or not the road width W of the traveling road R of the own vehicle 1 derived by the traveling status deriving unit 22B is less than the first width. Then, if the display control unit 22C determines that the road width W of the traveling road R of the own vehicle 1 is less than the first width, the display control unit 22C switches the display on the electronic mirror 18 from the second display image V2 to the rear image VB. By the switching processing of the display from the second display image V2 to the rear image VB, if the two-wheeled vehicle 2A1 is less likely to pass through the side of the own vehicle 1 and travel, the display control unit 22C can switch the second display image V2 to the rear image VB and display the rear image VB on the electronic mirror 18.

In addition, if the vehicle speed of the own vehicle 1 is greater than or equal to the first speed during the display of the second display image V2 on the electronic mirror 18, the display control unit 22C switches the display on the electronic mirror 18 from the second display image V2 to the rear image VB.

The display control unit 22C may determine whether or not the vehicle speed of the own vehicle 1 derived by the traveling status deriving unit 22B is greater than or equal to the first speed. Then, when determining that the vehicle speed of the own vehicle 1 is greater than or equal to the first speed during the display of the second display image V2 on the electronic mirror 18, the display control unit 22C switches the display on the electronic mirror 18 from the second display image V2 to the rear image VB. By the switching processing of the display from the second display image V2 to the rear image VB, if the two-wheeled vehicle 2A1 that does not appear in the rear image VB but appears in the rear side image VS is less likely to pass through the side of the own vehicle 1 and travel, the display control unit 22C can switch the second display image V2 to the rear image VB and display the rear image VB on the electronic mirror 18.

In addition, if the inter-vehicle distance between the own vehicle 1 and the other vehicle 2 traveling following the own vehicle 1 is greater than or equal to the first distance during the display of the second display image V2 on the electronic mirror 18, the display control unit 22C switches the display on the electronic mirror 18 from the second display image V2 to the rear image VB.

The display control unit 22C may determine whether or not the inter-vehicle distance between the own vehicle 1 and the other vehicle 2 traveling following the own vehicle 1 derived by the traveling status deriving unit 22B is greater than or equal to the first distance. Then, if the inter-vehicle distance between the own vehicle 1 and the other vehicle 2 traveling following the own vehicle 1 is greater than or equal to the first distance, the display control unit 22C switches the display on the electronic mirror 18 from the second display image V2 to the rear image VB. By the switching processing of the display from the second display image V2 to the rear image VB, if the inter-vehicle distance to the two-wheeled vehicle 2A1 is greater than or equal to the first distance and the driver can easily recognize the two-wheeled vehicle 2A1, the display control unit 22C can switch the second display image V2 to the rear image VB and display the rear image VB on the electronic mirror 18.

In addition, if the other vehicle 2 appearing in the rear image VB is a predetermined vehicle requiring caution during the display of the second display image V2 on the electronic mirror 18, the display control unit 22C switches the display on the electronic mirror 18 from the second display image V2 to the rear image VB.

If the traveling status deriving unit 22B derives that an emergency vehicle such as a fire engine or an ambulance, as a tailgating vehicle, or the like appears in the rear image VB, the display control unit 22C may switch the display on the electronic mirror 18 from the second display image V2 to the rear image VB. By the switching processing of the display from the second display image V2 to the rear image VB, the display control unit 22C can provide the vehicle requiring caution appearing in the rear image VB to the driver so as to be easily visually recognizable.

In addition, if the vehicle requiring caution appearing in the rear image VB is present in a region on which the rear side image VS is to be superimposed in the rear image VB included in the second display image V2 during the display of the second display image V2 on the electronic mirror 18, the display control unit 22C switches the display on the electronic mirror 18 from the second display image V2 to the rear image VB.

The display control unit 22C may determine whether or not the position in the rear image VB of the vehicle requiring caution appearing in the rear image VB derived by the traveling status deriving unit 22B is a region on which the rear side image VS is to be superimposed in the displayed second display image V2. Then, if the vehicle requiring caution appearing in the rear image VB is present in a region on which the rear side image VS is to be superimposed in the rear image VB included in the second display image V2, the display control unit 22C switches the display on the electronic mirror 18 from the second display image V2 to the rear image VB. By the switching processing of the display from the second display image V2 to the rear image VB, the display control unit 22C can provide the vehicle requiring caution appearing in the rear image VB to the driver so as to be easily visually recognizable.

In addition, when determining that the own vehicle 1 cannot change the lane or turn right or left during the display of the second display image V2 on the electronic mirror 18, the display control unit 22C switches the display on the electronic mirror 18 from the second display image V2 to the rear image VB.

The display control unit 22C may determine whether or not the own vehicle 1 is in a state where a change of the lane or a right/left turn is impossible by acquiring information indicating whether or not the own vehicle 1 cannot change the lane or turn right or left, which is derived by the traveling status deriving unit 22B. Then, when determining that the own vehicle 1 cannot change the lane or turn right or left during the display of the second display image V2 on the electronic mirror 18, the display control unit 22C switches the display on the electronic mirror 18 from the second display image V2 to the rear image VB. By the switching processing of the display from the second display image V2 to the rear image VB, if the two-wheeled vehicle 2A1 is less likely to pass through the side of the own vehicle 1 and travel, the display control unit 22C can switch the display from the second display image V2 to the rear image VB.

Next, an example of a procedure of information processing executed by the information processing apparatus 10 of the present embodiment will be described.

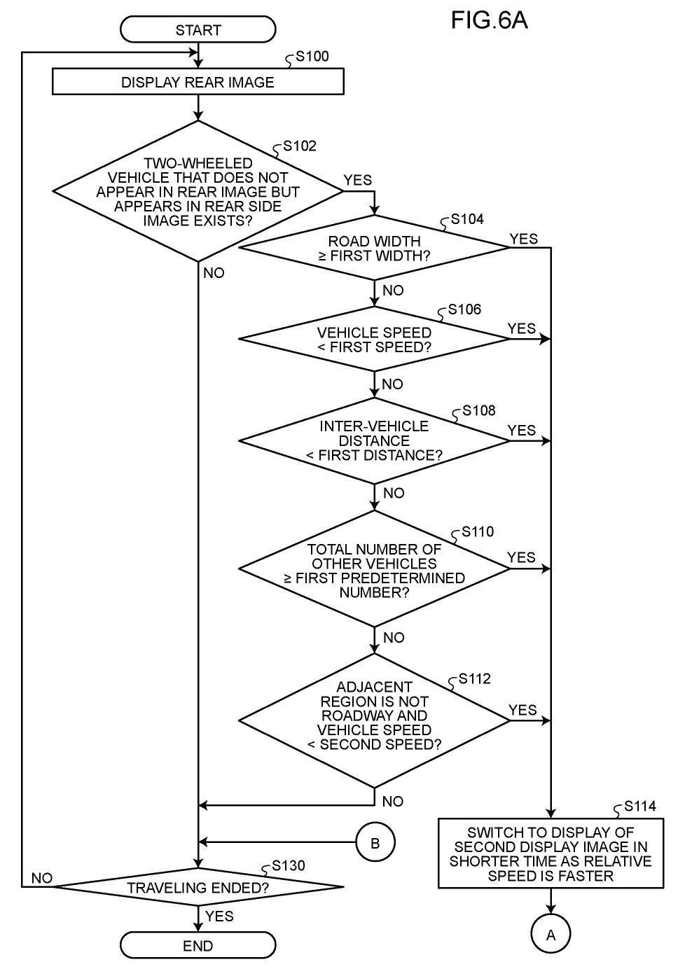

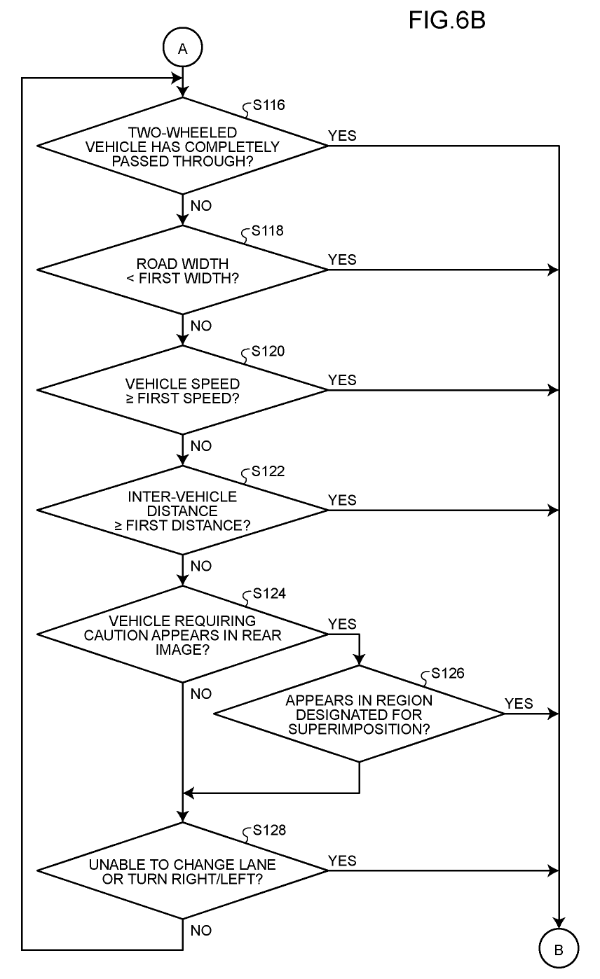

FIGS. 6A and 6B are flowcharts illustrating an example of a procedure of information processing executed by the information processing apparatus 10.

The display control unit 22C displays, on the electronic mirror 18, the rear image VB captured by the rear imaging unit 13 that images the rear of the own vehicle 1 (Step S100).

The display control unit 22C determines whether or not the two-wheeled vehicle 2A1 that does not appear in the rear image VB but appears in the rear side image VS exists (Step S102). When making a negative determination in Step S102 (Step S102: No), the process proceeds to Step S130 described later. When making a positive determination in Step S102 (Step S102: Yes), the process proceeds to Step S104.

In Step S104, the display control unit 22C determines whether or not the road width W of the traveling road R of the own vehicle 1 is greater than or equal to the first width (Step S104). When making a positive determination in Step S104 (Step S104: Yes), the process proceeds to Step S114. When making a negative determination in Step S104 (Step S104: No), the process proceeds to Step S106.

In Step S106, the display control unit 22C determines whether or not the vehicle speed of the own vehicle 1 is less than the first speed (Step S106). When making a positive determination in Step S106 (Step S106: Yes), the process proceeds to Step S114. When making a negative determination in Step S106 (Step S106: No), the process proceeds to Step S108.

In Step S108, the display control unit 22C determines whether or not the inter-vehicle distance between the own vehicle 1 and the other vehicle 2 traveling following the own vehicle 1 is less than the first distance (Step S108). When making a positive determination in Step S108 (Step S108: Yes), the process proceeds to Step S114. When making a negative determination in Step S108 (Step S108: No), the process proceeds to Step S110.

In Step S110, the display control unit 22C determines whether or not the total number of the other vehicles 2 appearing in the rear image VB is larger than or equal to the first predetermined number (Step S110). When making a positive determination in Step S110 (Step S110: Yes), the process proceeds to Step S114. When making a negative determination in Step S110 (Step S110: No), the process proceeds to Step S112.

In Step S112, the display control unit 22C determines whether or not the adjacent region adjacent to the lane of the own vehicle 1 is not a roadway and the vehicle speed of the own vehicle 1 is less than the second speed (Step S112). When making a positive determination in Step S112 (Step S112: Yes), the process proceeds to Step S114. When making a negative determination in Step S112 (Step S112: No), the process proceeds to Step S130.

In Step S114, the display control unit 22C switches the display on the electronic mirror 18 from the rear image VB to the second display image V2 (Step S114). At this time, preferably the display control unit 22C switches the display on the electronic mirror 18 from the rear image VB to the second display image V2 in a shorter time after the determination that the first condition and the second condition are satisfied as the relative speed of the two-wheeled vehicle 2A1 that satisfies the first condition with respect to the own vehicle 1 is faster.

Then, the process proceeds to Step S116.

In Step S116, the display control unit 22C determines whether or not the two-wheeled vehicle 2A1 satisfying the first condition determined in Step S102 has completely passed through the side of the own vehicle 1 (Step S116). The display control unit 22C determines whether or not the distance from the two-wheeled vehicle 2A1 appearing in the rear side image VS has decreased from a predetermined distance or more to less than the predetermined distance, and the two-wheeled vehicle 2A1 no longer appears in the rear side image VS, thereby making the determination in Step S116. When making a positive determination in Step S116 (Step S116: Yes), the process proceeds to Step S130. When making a negative determination in Step S116 (Step S116: No), the process proceeds to Step S118.

In Step S118, the display control unit 22C determines whether or not the road width W of the traveling road R of the own vehicle 1 is less than the first width (Step S118). When making a positive determination in Step S118 (Step S118: Yes), the process proceeds to Step S130. When making a negative determination in Step S118 (Step S118: No), the process proceeds to Step S120.

In step S120, the display control unit 22C determines whether or not the vehicle speed of the own vehicle 1 is greater than or equal to the first speed (step S120). When making a positive determination in Step S120 (Step S120: Yes), the process proceeds to Step S130. When making a negative determination in Step S120 (Step S120: No), the process proceeds to Step S122.

In step S122, the display control unit 22C determines whether or not the inter-vehicle distance between the own vehicle 1 and the other vehicle 2 traveling following the own vehicle 1 is greater than or equal to the first distance (step S122). When making a positive determination in Step S122 (Step S122: Yes), the process proceeds to Step S130. When making a negative determination in Step S122 (Step S122: No), the process proceeds to Step S124.

In step S124, the display control unit 22C determines whether or not the other vehicle 2 appearing in the rear image VB is a vehicle requiring caution (step S124). When making a positive determination in Step S124 (Step S124: Yes), the process proceeds to Step S126.

In Step S126, the display control unit 22C determines whether or not the vehicle requiring caution appearing in the rear image VB is present in a region on which the rear side image VS is to be superimposed in the rear image VB included in the second display image V2 (Step S126). When making a positive determination in Step S126 (Step S126: Yes), the process proceeds to Step S130. When making a negative determination in Step S126 (Step S126: No), the process proceeds to Step S128.

In Step S128, the display control unit 22C determines whether or not the own vehicle 1 is in a state where a change of the lane or a right/left turn is impossible (Step S128). When making a positive determination in Step S128 (Step S128: Yes), the process proceeds to Step S130. When making a negative determination in Step S128 (Step S128: No), the process returns to Step S116.

In Step S130, the display control unit 22C determines whether or not the own vehicle 1 has finished traveling (Step S130). For example, the display control unit 22C determines whether or not the engine of the own vehicle 1 is stopped and a signal indicating a shut-off instruction of power supplied to each unit of the own vehicle 1 is received, thereby executing the determination of step S130. When making a negative determination in Step S130 (Step S130: No), the process returns to Step S100 described above. When an affirmative determination is made in Step S130 (Step S130: Yes), this routine is ended.

As described above, the information processing apparatus 10 of the present embodiment includes the display control unit 22C. The display control unit 22C displays, on the electronic mirror 18 (display device) provided on the own vehicle 1, the rear image VB captured by the rear imaging unit 13 that images the rear of the own vehicle 1. When satisfying the first condition that there exists the two-wheeled vehicle 2A1 that does not appear in the rear image VB but appears in the rear side image VS captured by the rear side imaging unit 12 that images the left rear side and the right rear side of the own vehicle 1, the display control unit 22C displays the second display image V2 in which the rear side image VS is superimposed on a part of the rear image VB on the electronic mirror 18 (display device).

Here, in the related art, there is a case where the display on the electronic mirror 18 is switched to the image of the side camera only even in a situation where it is necessary to cause the driver to confirm the image captured by the rear camera. Further, in the related art, even in a situation where it is necessary to cause the driver to confirm the image captured by the side camera, only the image of the rear camera is displayed on the electronic mirror 18 in some cases. Therefore, in the related art, there is a case where visibility of a situation around the own vehicle is reduced.

On the other hand, in the information processing apparatus 10 of the present embodiment, when satisfying the first condition that there exists the two-wheeled vehicle 2A1 that does not appear in the rear image VB but appears in the rear side image VS captured by the rear side imaging unit 12 that images the left rear side and the right rear side of the own vehicle 1, the display control unit 22C displays the second display image V2 in which the rear side image VS is superimposed on a part of the rear image VB on the electronic mirror 18 (display device).

Therefore, in the information processing apparatus 10 of the present embodiment, it is possible to superimpose and display the image V in which the two-wheeled vehicle 2A1 existing on the rear side of the own vehicle 1 appears on the rear image VB at an appropriate timing while continuing the display of the rear image VB on the electronic mirror 18.

Therefore, the information processing apparatus 10 of the present embodiment can improve the visibility for the driver of the situation around the own vehicle 1.

Therefore, the information processing apparatus 10 of the present embodiment can improve the visibility of the situation around the own vehicle 1.

Note that, in the present embodiment, a mode in which the information processing apparatus 10 is mounted on the own vehicle 1 has been described as an example. However, the information processing apparatus 10 may be mounted outside the own vehicle 1. The information processing apparatus 10 is communicably connected to various electronic devices such as the rear side imaging unit 12, the rear imaging unit 13, the sensor 14, the UI unit 15, the travel control unit 16, the electronic mirror 18, and the storage unit 19 provided in the own vehicle 1. Therefore, the information processing apparatus 10 may be mounted on an information processing apparatus provided outside the own vehicle 1. In this case, the information processing apparatus on which the information processing apparatus 10 is mounted and the above-described various electronic devices may be configured to be communicable via a network or the like. Furthermore, in this case, a vehicle communicably connected to the information processing apparatus 10 corresponds to the own vehicle 1.

Furthermore, at least a part of the function of the display control unit 22C in the information processing apparatus 10 may be executed by a system on a chip (SoC) provided in the information processing apparatus 10. For example, in the information processing apparatus 10, the rear image VB captured by the rear imaging unit 13 may be displayed on the electronic mirror 18, and when it is determined that the first condition is satisfied, the SoC may generate the second display image V2 and display the second display image V2 on the electronic mirror 18. Further, the SoC may execute both the display of the rear image VB on the electronic mirror 18 and the generation and display of the second display image V2 on the electronic mirror 18.

According to the information processing apparatus, the information processing method, and the information processing program according to an embodiment, it is possible to improve the visibility of the situation around the own vehicle.

Note that the present technology can also have the following configurations.

### 1

An information processing apparatus including a display control unit configured to:

display a rear image captured by a rear imaging unit configured to image rear of an own vehicle on a display device provided on the own vehicle, wherein

when satisfying a first condition that there exists a two-wheeled vehicle not appearing in the rear image but appearing in rear side images captured by rear side imaging units configured to image a left rear side and a right rear side of the own vehicle, display a second display image in which the rear side image is superimposed on a part of the rear image on the display device.

### 2

The information processing apparatus according to (1), wherein

when satisfying the first condition, and

satisfying a second condition that is at least one of: a road width of a traveling road of the own vehicle being larger than or equal to a first width; a vehicle speed of the own vehicle being less than a first speed; an inter-vehicle distance between the own vehicle and another vehicle traveling following the own vehicle being less than a first distance; a total number of other vehicles appearing in the rear image being larger than or equal to a first predetermined number; and an adjacent region adjacent to a lane of the own vehicle being not a roadway and a vehicle speed of the own vehicle being less than a second speed,

the display control unit is configured to display the second display image on the display device.

### 3

The information processing apparatus according to (2), wherein

when satisfying the first condition and the second condition, the display control unit is configured to switch the rear image to the second display image to display it on the display device in a shorter time from the determination that the first condition and the second condition are satisfied as a relative speed of the two-wheeled vehicle with respect to the own vehicle is faster.

### 4

The information processing apparatus according to any one of (1) to (3), wherein

the display control unit is configured to switch the second display image to the rear image to display it on the display device when satisfying a third condition that is at least one of: a distance from the two-wheeled vehicle appearing in the rear side image being changed from greater than or equal to a predetermined distance to less than the predetermined distance and the two-wheeled vehicle no longer appearing in the rear side image; the road width of the traveling road of the own vehicle being less than the first width; the vehicle speed of the own vehicle being greater than or equal to the first speed; the inter-vehicle distance from another vehicle traveling following the own vehicle being greater than or equal to the first distance; another vehicle appearing in the rear image being a predetermined vehicle requiring caution; the vehicle requiring caution appearing in the rear image being present in a region on which the rear side image is to be superimposed in the rear image included in the second display image; and the own vehicle being unable to change the lane or turn right or left.

### 5

The information processing apparatus according to any one of (1) to (4), wherein

the display control unit is configured to display, on the display device, the second display image in which the rear side image in which the two-wheeled vehicle is appearing is superimposed on a part of the rear image.

### 6

The information processing apparatus according to any one of (1) to (5), wherein

the display control unit is configured to display, on the display device, the second display image in which the rear side image corresponding to a direction in which the two-wheeled vehicle is detected is superimposed on a region corresponding to a detection direction of the two-wheeled vehicle with respect to the own vehicle in the rear image.

### 7

The information processing apparatus according to any one of (1) to (6), wherein

the display control unit is configured to display, on the display device, the second display image in which the rear side image is superimposed on a region outside a prescribed region of a prescribed view angle range and corresponding to the detection direction of the two-wheeled vehicle with respect to the own vehicle in the rear image.

### 8

The information processing apparatus according to (7), wherein

the display control unit is configured to display, on the display device, the second display image in which the center of the rear image is arranged at a position shifted from the center of a display region of the display device and the rear side image is superimposed outside the prescribed region of the rear image.

### 9

The information processing apparatus according to (7) or (8), wherein

the display control unit is configured to display, on the display device, the second display image obtained by cutting out, from the rear side image, a region including the two-wheeled vehicle appearing in the rear side image, and superimposing it onto the region outside the prescribed region in the rear image.

### 10

An information processing method executed by an information processing apparatus, the information processing method including

displaying a rear image captured by a rear imaging unit configured to image rear of an own vehicle on a display device provided on the own vehicle, wherein

when satisfying a first condition that there exists a two-wheeled vehicle not appearing in the rear image but appearing in rear side images captured by rear side imaging units configured to image a left rear side and a right rear side of the own vehicle, displaying a second display image in which the rear side image is superimposed on a part of the rear image on the display device.

### 11

An information processing program for causing the computer to perform

displaying a rear image captured by a rear imaging unit configured to image rear of an own vehicle on a display device provided on the own vehicle, wherein

when satisfying a first condition that there exists a two-wheeled vehicle not appearing in the rear image but appearing in rear side images captured by rear side imaging units configured to image a left rear side and a right rear side of the own vehicle, displaying a second display image in which the rear side image is superimposed on a part of the rear image on the display device.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising
a memory in which a program is stored; and
a processor coupled to the memory and configured to perform processing by executing the program, the processing including
displaying a rear image captured by a rear camera configured to image rear of an own vehicle on a display device provided on the own vehicle, wherein the processing includes
when satisfying a first condition that there exists a two-wheeled vehicle not appearing in the rear image but appearing in rear side images captured by rear side cameras configured to image a left rear side and a right rear side of the own vehicle, displaying a second display image in which the rear side image is superimposed on a part of the rear image on the display device.

2. The information processing apparatus according to claim 1, wherein
the processing includes
when satisfying the first condition, and
satisfying a second condition that is at least one of: a road width of a traveling road of the own vehicle being larger than or equal to a first width; a vehicle speed of the own vehicle being less than a first speed; an inter-vehicle distance between the own vehicle and another vehicle traveling following the own vehicle being less than a first distance; a total number of other vehicles appearing in the rear image being larger than or equal to a first predetermined number; and an adjacent region adjacent to a lane of the own vehicle being not a roadway and a vehicle speed of the own vehicle being less than a second speed,
displaying the second display image on the display device.

3. The information processing apparatus according to claim 2, wherein
the processing includes
when satisfying the first condition and the second condition, switching the rear image to the second display image to display it on the display device in a shorter time from the determination that the first condition and the second condition are satisfied as a relative speed of the two-wheeled vehicle with respect to the own vehicle is faster.

4. The information processing apparatus according to claim 2, wherein
the processing includes switching the second display image to the rear image to display it on the display device when satisfying a third condition that is at least one of: a distance from the two-wheeled vehicle appearing in the rear side image being changed from greater than or equal to a predetermined distance to less than the predetermined distance and the two-wheeled vehicle no longer appearing in the rear side image; the road width of the traveling road of the own vehicle being less than the first width; the vehicle speed of the own vehicle being greater than or equal to the first speed; the inter-vehicle distance from another vehicle traveling following the own vehicle being greater than or equal to the first distance; another vehicle appearing in the rear image being a predetermined vehicle requiring caution; the vehicle requiring caution appearing in the rear image being present in a region on which the rear side image is to be superimposed in the rear image included in the second display image; and the own vehicle being unable to change the lane or turn right or left.

5. The information processing apparatus according to claim 1, wherein
the processing includes displaying, on the display device, the second display image in which the rear side image in which the two-wheeled vehicle is appearing is superimposed on a part of the rear image.

6. The information processing apparatus according to claim 1, wherein
the processing includes displaying, on the display device, the second display image in which the rear side image corresponding to a direction in which the two-wheeled vehicle is detected is superimposed on a region corresponding to a detection direction of the two-wheeled vehicle with respect to the own vehicle in the rear image.

7. The information processing apparatus according to claim 1, wherein
the processing includes displaying, on the display device, the second display image in which the rear side image is superimposed on a region outside a prescribed region of a prescribed view angle range and corresponding to the detection direction of the two-wheeled vehicle with respect to the own vehicle in the rear image.

8. The information processing apparatus according to claim 7, wherein
the processing includes displaying, on the display device, the second display image in which the center of the rear image is arranged at a position shifted from the center of a display region of the display device and the rear side image is superimposed outside the prescribed region of the rear image.

9. The information processing apparatus according to claim 7, wherein
the processing includes displaying, on the display device, the second display image obtained by cutting out, from the rear side image, a region including the two-wheeled vehicle appearing in the rear side image, and superimposing it onto the region outside the prescribed region in the rear image.

10. The information processing apparatus according to claim 1, wherein
the processing includes displaying the rear image and the second image as an image for an electronic mirror.

11. The information processing apparatus according to claim 4, wherein the vehicle requiring caution includes an emergency vehicle and a tailgating vehicle.

12. The information processing apparatus according to claim 4, wherein, the processing includes deriving the own vehicle being unable to change the lane or turn right or left is satisfied in a state in which the traveling road of the own vehicle is one lane on one side.

13. The information processing apparatus according to claim 1, wherein the processing includes displaying the rear side image of the right rear side of the own vehicle on a right end in the second image, and displaying the rear side image of the left rear side of the own vehicle on a left end in the second image.

14. An information processing method executed by an information processing apparatus, the information processing method comprising
displaying a rear image captured by a rear camera configured to image rear of an own vehicle on a display device provided on the own vehicle, wherein the method comprises
when satisfying a first condition that there exists a two-wheeled vehicle not appearing in the rear image but appearing in rear side images captured by rear side cameras configured to image a left rear side and a right rear side of the own vehicle, displaying a second display image in which the rear side image is superimposed on a part of the rear image on the display device.

15. A computer program product including programmed instructions embodied in and stored on a non-transitory computer readable medium, wherein the instructions, when executed by a computer, cause the computer to perform
displaying a rear image captured by a rear camera configured to image rear of an own vehicle on a display device provided on the own vehicle, wherein the programmed instructions cause the computer to perform
when satisfying a first condition that there exists a two-wheeled vehicle not appearing in the rear image but appearing in rear side images captured by rear side cameras configured to image a left rear side and a right rear side of the own vehicle, displaying a second display image in which the rear side image is superimposed on a part of the rear image on the display device.
